(19) United States
(12) Patent Application Publication
(10) Pub. No.: US 2023/0038979 A1
(43) Pub. Date: Feb. 9, 2023

(54) DEVICE FOR CLEANING AN OPTICAL SYSTEM

(71) Applicant: Valeo Systemes d'Essuyage, La Verriere (FR)

(72) Inventors: Baptiste BEZIAT, La Verriere (FR); Margaux BEAUBET, La Verriere (FR)

(73) Assignee: Valeo Systemes d'Essuyage, La Verriere (FR)

(21) Appl. No.: 17/764,356

(22) PCT Filed: Sep. 2, 2020
(86) PCT No.: PCT/EP2020/074405

§ 371 Date: Oct. 31, 2022

(30) Foreign Application Priority Data
Oct. 4, 2019 (FR) 1911041

(51) Int. Cl. B60S 1/56; B60S 1/48; B60S 1/52

(52) U.S. Cl. CPC B60S 1/56; B60S 1/481; B60S 1/522

(57) ABSTRACT

The present invention relates to a cleaning device for cleaning at least one optical system of a vehicle, comprising an actuator which has an actuator body which delimits a chamber, a piston with the ability to move in the chamber, and a rod connected to the piston, one end of the rod emerging from the actuator body, said rod comprising at least one cleaning-fluid-spraying element formed at the end of the rod, the rod comprising at least one cleaning-fluid circulation duct which connects the chamber to said at least one spraying element, characterized in that the cleaning device comprises at least one switch activated according to the position of the piston.

The present invention relates to the field of devices for cleaning a vehicle, and more particularly to devices for cleaning optical systems arranged in a vehicle.

With the progress of automotive market innovation, the number of optical systems present in a vehicle, for example sensors, has increased significantly in recent years. As such, the need to clean such optical systems was quickly felt.

It is known to set up a cleaning device close to the optical systems with a cylinder comprising a rod which emerges from a cylinder body and which sprays a cleaning fluid onto the optical system by means of a spraying element located at the emerging end of the rod. The device is activated for example after activation of a button. The rod then emerges from the cylinder body and the spraying element travels a distance until it is stopped at a maximum position, the cleaning fluid being sprayed over the entire duration of this operation. During the movement of the rod, the jet of cleaning fluid therefore sweeps a region in which the optical surface of the optical system is located and thus cleans it.

The problem caused by this cleaning device is that the latter is programmed to spray the cleaning fluid for a certain period of time, the latter being deliberately long to cover different spraying situations depending on the speed of movement of the vehicle, for example. Thus, a non-negligible quantity of cleaning fluid is not sprayed onto the optical system and causes the latter to be wasted over the long term.

The present invention proposes to overcome this problem by proposing a cleaning device for cleaning at least one optical system of a vehicle, comprising a cylinder which comprises a cylinder body which delimits a chamber, a piston capable of moving in the chamber, and a rod connected to the piston, one end of the rod emerging from the cylinder body, said rod comprising at least one cleaning fluid spraying element provided at the end of the rod, the rod comprising at least one cleaning fluid circulation channel which connects the chamber to said at least one spraying element, characterized in that the cleaning device comprises a switch activated according to the position of the piston.

The cylinder body is configured to allow the emergence of the rod out of it. The piston is positioned on the end of the rod opposite the end comprising the spraying element. With the piston being connected to the end of the rod, it is therefore the movement of the piston which causes the emergence of the rod out of the cylinder body, but also the return of the latter within the cylinder body once the cleaning of the optical system has been carried out. The cleaning fluid circulation channel passes through the rod as well as the piston to open into the chamber. The cleaning fluid circulation channel therefore extends from the chamber to the spraying element, the chamber and the spraying element being filled with the cleaning fluid when the cleaning device is activated.

The switch is activated by means of the piston. The switch is therefore arranged so as to be partially located on the piston as well as on a region of the cylinder body located close to the passage of the piston. The switch is therefore activated according to an interaction between the piston and the cylinder body. In other words, the activation of the switch makes it possible to determine a precise position of the piston within the cylinder body. The switch can be activated for example following an electrical or magnetic interaction. Activation is understood to mean the implementation of a normally open or normally closed switch, an electrical circuit being adapted to the type of switch used.

According to one feature of the invention, the switch comprises at least two electrical terminals integral with the cylinder body and a contacting member carried by the piston, the switch being configured to be activated when said at least two electrical terminals are electrically brought into contact by the contacting member. This is a first embodiment of the cleaning device. The two electrical terminals are part of an electrical circuit extending partly within the cylinder body. The circuit is interrupted between the two electrical terminals, which therefore prevents current from flowing. The switch is therefore inactive as long as the electrical circuit is open between the two electrical terminals, that is to say in the absence of contact between the contacting member and the two electrical terminals.

The contacting member is arranged against the piston and comprises a conductive surface. The contacting member has dimensions adapted to come into simultaneous contact with the two electrical terminals. Thus, upon contact between the two electrical terminals and the contacting member, the latter creates an electrically conductive bridge between the two electrical terminals and thus closes the electrical circuit. The switch is then activated.

According to one feature of the invention, the body of the cylinder comprises a tubular portion comprising two ends, and two end walls arranged respectively at said two ends, said at least two electrical terminals being carried by one of the end walls. The piston carries out a longitudinal movement along the tubular portion of the cylinder body, the movement of the piston stopping substantially at each of the end walls of the cylinder body. One of the end walls of the cylinder body comprises at least one opening to allow the rod to pass out of the cylinder body.

Advantageously, the electrical terminals are arranged on the end wall comprising the opening, more precisely on an internal face of the end wall, that is to say the face oriented in the direction of the piston. Thus, the switch is activated when the piston, more particularly the contacting member, is pressed against the two electrical terminals. In other words, the switch is activated when the piston is at the end of the cylinder body and the rod reaches its maximum capacity to emerge from the cylinder body. This first embodiment of the cleaning device therefore makes it possible to determine the position of the piston when the latter is at one end of the cylinder body.

According to one feature of the invention, the switch comprises at least one magnet carried by the piston and at least one magnetic sensor carried by the cylinder body, the switch being configured to be activated when said at least one magnet is facing said at least one magnetic sensor. In this second embodiment of the cleaning device, the switch is activated during a magnetic interaction between the magnet on the one hand and the magnetic sensor on the other hand. The principle remains identical to the first embodiment, namely that the switch is activated when the piston is close to a particular region of the cylinder body. Like the two electrical terminals, the magnetic sensor is connected to an electrical circuit, kept open as long as the magnet is not close to the electrical sensor. This second embodiment of the cleaning device therefore makes it possible to determine the position of the piston when the latter is either at one end of the cylinder body or in a determined position located between the two longitudinal ends of the cylinder body.

According to one feature of the invention, the body of the cylinder comprises a tubular portion comprising two ends, and two end walls arranged respectively at said two ends, said at least one magnetic sensor being arranged in the tubular portion. In terms of shapes and dimensions, the cylinder body has features identical to what has been described above. The fact that the magnetic sensor is arranged in the tubular portion offers a greater influence as to the position of the piston when the switch is activated, unlike the first embodiment where the switch is activated when the piston is positioned at one end of the cylinder body, more particularly substantially against one of the end walls thereof.

According to one feature of the invention, the switch is activated when the magnet is facing the magnetic sensor. In other words, the switch is activated when a first transverse plane passing through the center of the magnet coincides with a second transverse plane passing through the center of the magnetic sensor. The passage of the magnet facing the magnetic sensor causes the closure of the electrical circuit at the magnetic sensor.

According to one feature of the invention, the switch can comprise a plurality of magnetic sensors configured to be arranged in a plurality of positions along the tubular portion. The second embodiment has the advantage of having freedom of positioning of the magnetic sensor over substantially the entire length of the tubular portion. In other words, it is possible to determine the position of the piston with respect to the cylinder body when the switch is activated according to the choice of positioning of the magnetic sensor. Such freedom of positioning makes it possible to standardize the cleaning device according to the invention and to adapt it to the needs of each vehicle model, so as to have a piston stop specific for example to the positioning or to the dimensions of the optical system that the cleaning device is intended to clean. It is also conceivable to arrange a plurality of magnetic sensors along the tubular portion in the case where the cleaning device is configured to clean a plurality of optical systems.

The invention also covers a cleaning system for cleaning at least one optical system of a vehicle, comprising at least one cleaning device as described above, a cleaning fluid reservoir and a pump which transfers the cleaning fluid from the reservoir to the chamber of the cylinder, the operation of the pump being placed under the dependence of the switch. The cleaning fluid reservoir and the cylinder chamber can for example be connected by a cleaning fluid pipe which passes in particular through one of the end walls of the cylinder body. The pump allows the circulation of the cleaning fluid from the reservoir to the cylinder chamber. The filling of the chamber with the cleaning fluid creates a pressure on the piston which causes the movement of the latter toward the end wall opposite the end wall of the cylinder body through which the cleaning fluid flows. It should be noted that the piston is connected to a spring which compresses following the movement thereof. The spring has a resistance force less than the pressure force exerted by the cleaning fluid on the piston, hence the compression of said spring.

In addition to causing the piston to move, the cleaning fluid also enters the cylinder rod circulation channel. The circulation channel has a sufficiently small diameter which tends to increase the pressure of the cleaning fluid at the spraying element. The cleaning fluid then flows into or along the cylinder rod via the circulation channel until it is sprayed onto the optical surface by the spraying element. The piston, subjected to the pressure of the cleaning fluid which fills the cylinder chamber, is moved until the switch is activated, by contact between the two electrical terminals and the contacting member according to the first embodiment, or by magnetism between the magnet and the magnetic sensor according to the second embodiment, thereby interrupting the operation of the pump.

According to one feature of the invention, the operation of the pump is interrupted when the switch is activated. The pump is electrically connected to a supply circuit comprising a generator, a first switch and a second switch. The switches can each have an open position and a closed position. Electric current only flows if both switches are in the closed position. When the cleaning system is inactive, the first switch is in the open position and the second switch is in the closed position. The first switch is capable of switching to the closed position, for example following a manual command carried out by a motorist driving the vehicle, or automatically if the optical system relating to the cleaning system is equipped with a detector indicating the presence of impurities at an optical surface of the optical system that need to be removed.

When the first switch switches to the closed position, the supply circuit is completely closed and therefore causes the operation of the pump which ensures the circulation of the cleaning fluid from the reservoir to the cylinder chamber. The cleaning fluid causes the piston to move while being sprayed against the optical system by the spraying element of the rod. The piston moves until causing the switch to activate. The switch being activated, the electrical circuit is then closed and supplies an electrical relay capable of acting on the supply circuit of the pump, more particularly on the second switch to make it switch to the open position.

In this situation, the supply circuit is then cut off and the pump stops. The cleaning fluid no longer exerts pressure on the piston and is no longer sprayed via the spraying element. Since the spring is no longer subjected to the pressure of the piston, it then relaxes to return to its initial position, causing the movement of the piston toward the end wall of the cylinder body and the concomitant movement of the spraying element. The latter, no longer exerting any pressure, is then subjected to the pressure of the piston and is forced into the circulation pipe until it returns to the reservoir. The switch, through its activation, therefore prevents the cleaning fluid from being unnecessarily wasted by being sprayed after having cleaned the optical system. In general, the activation of the switch is for example capable of causing the opening or closing of the electrical circuit and/or of the switch, or any other action leading to the interruption of the pump.

The invention also covers a method for cleaning an optical system of a vehicle implementing a cleaning system as described above, in which:
the pump is put into operation so as to cause a movement of the piston and spraying of the cleaning fluid onto the optical system,
the switch is activated according to the position of the piston, and
the operation of the pump is interrupted when the switch is activated.

Further features and advantages of the invention will become more clearly apparent from the following description, on the one hand, and from a plurality of exemplary embodiments, which are provided by way of nonlimiting indication with reference to the accompanying schematic drawings, on the other hand, in which drawings:

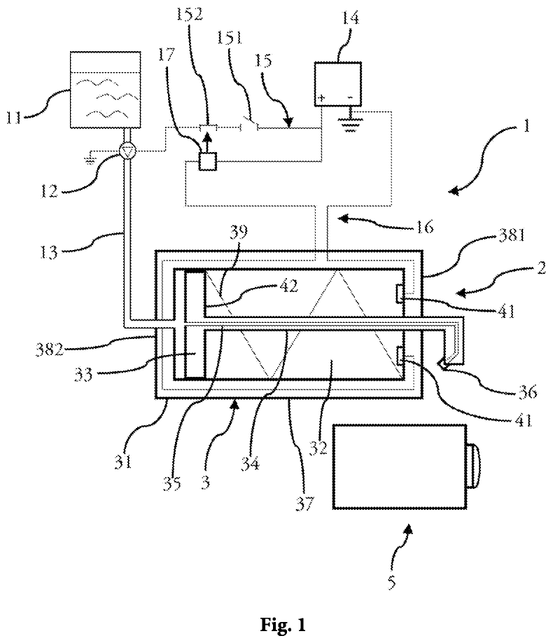

FIG. 1 is a schematic representation of a first embodiment of a cleaning device included within a cleaning system for cleaning an optical system, the cleaning system being inactive,

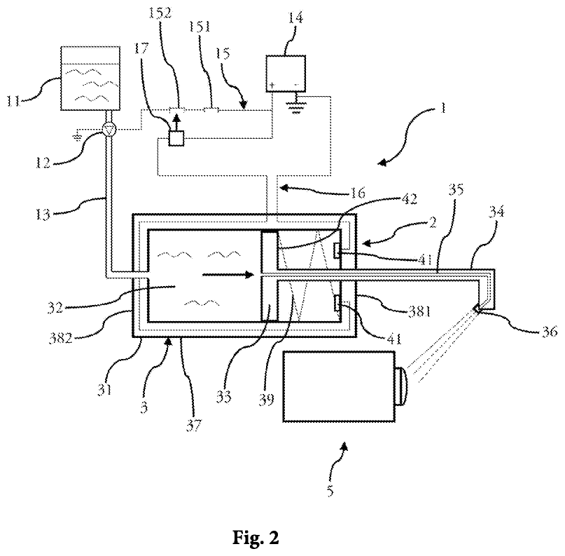

FIG. 2 is a schematic representation of the first embodiment, the cleaning system being active and the cleaning device spraying a cleaning fluid,

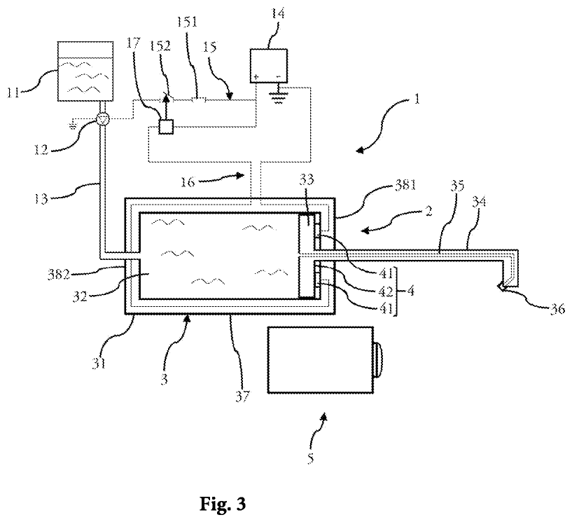

FIG. 3 is a schematic representation of the first embodiment, when activating a switch of the cleaning device,

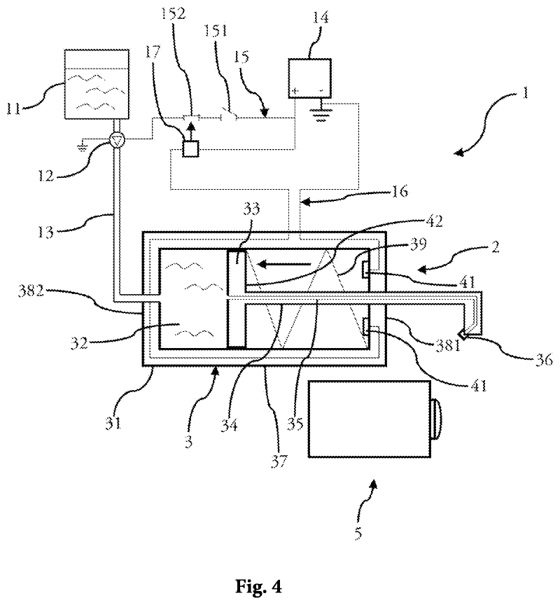

FIG. 4 is a schematic representation of the first embodiment, after activating the switch of the cleaning device,

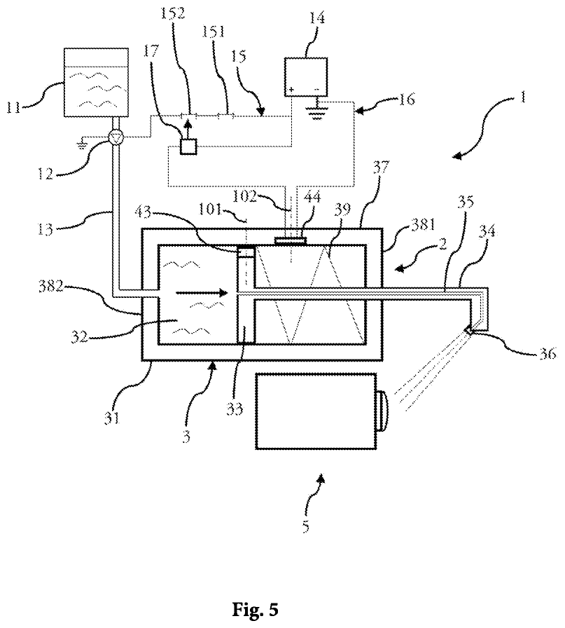

FIG. 5 is a schematic representation of a second embodiment of the cleaning device included within the cleaning system for cleaning the optical system, the cleaning system being active and the cleaning device spraying a cleaning fluid,

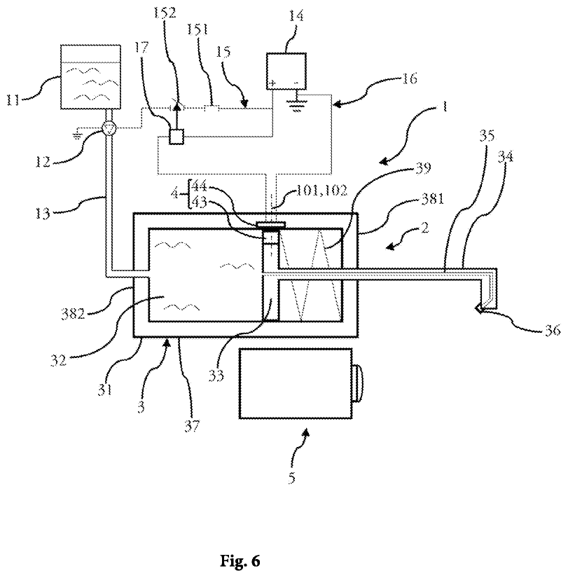

FIG. 6 is a schematic representation of the second embodiment, when activating the switch of the cleaning device.

FIG. 1 represents a cleaning system 1 suitable for cleaning an optical system 5. The optical system 5 can be of various kinds and is liable to be dirty. The cleaning system 1 has the function of cleaning the optical system 5 by spraying a cleaning fluid thereon. Such an optical system is for example a reversing radar, a reversing camera or a LIDAR-type optical system.

To do this, the cleaning system 1 comprises a cleaning device 2. The cleaning device 2 consists of a cylinder 3 which comprises at least one cylinder body 31 in the form of a tubular portion 37 closed at each of its ends by an end wall. The tubular portion 37 is of substantially cylindrical hollow shape. The end walls close each end of the cylindrical shape of the tubular portion 37. The end walls therefore have dimensions adapted to the diameter of the tubular portion 37. The tubular portion 37 and the end walls of the cylinder body 31 together delimit an internal volume termed chamber 32.

The cylinder 3 also comprises a piston 33 and a rod 34. The piston 33 has a substantially cylindrical shape whose diameter is substantially smaller than the diameter of the tubular portion 37 of the cylinder body 31 so that the piston 33 moves in translation within the chamber 32. The piston 33 is located at one end of the rod 34. The rod 34 has a main dimension parallel to an axis of revolution of the tubular portion 37. The rod 34 is capable of emerging from the cylinder body 31 by passing through a first end wall 381. As such, the first end wall 381 has an opening made for the passage of the rod 34. One end of the rod 34 emerging from the cylinder body 31 comprises a spraying element 36. The spraying element 36 can for example take the form of a spraying nozzle which sprays the cleaning fluid onto the optical system 5. The spraying element 36 is oriented with respect to the rod 34 so as to spray the cleaning fluid in the direction of the optical system 5. For the cleaning fluid to reach the spraying element 36, a circulation channel 35 is arranged within the rod 34 and extends from the spraying element 36 to emerge in the chamber 32 while passing through the rod 34 and the piston 33.

The cylinder 3 also comprises a spring 39. The spring 39 extends within the chamber 32, from the first end wall 381 to the piston 33. The spring 39 therefore exerts a mechanical force on the piston 33. In FIG. 1, the spring 39 is in its initial position, fully relaxed.

In addition to the cylinder 3, the cleaning device 2 also comprises a switch, for example an electrical switch. In this first embodiment, the switch is divided into two parts: a first part composed of two electrical terminals 41 and a second part composed of a contacting member 42. The electrical terminals 41 are both arranged on the first end wall 381, more particularly on a face of the first end wall 381 oriented toward the chamber 32. The contacting member 42, for its part, is arranged on a face of the piston 33 oriented toward the first end wall 381. The two electrical terminals 41 are electrically connected to an electrical circuit 16, which will be detailed later. The contacting member 42 covers the entire face of the piston 33 on which it is arranged. The contacting member 42 can for example be made of aluminum or any other conductive material. The switch is activated when the two electrical terminals 41 are in contact with the contacting member 42. In FIG. 1, the switch is inactive, the two electrical terminals 41 and the contacting member 42 being distant from one another.

The cleaning system 1 also comprises a cleaning fluid reservoir 11. The reservoir 11 has a capacity allowing the storage of the cleaning fluid and can for example be accessible in the context of manual refilling. The reservoir 11 is connected to a cleaning fluid pipe 13. The pipe 13 is equipped with a pump 12 and extends from the reservoir 11 to the cylinder 3, where it passes through a second end wall 382 of the cylinder body 31 to open into the chamber 32.

The pump 12 is supplied by a supply circuit 15 whose electric current is generated by an electric generator 14. The electrical circuit 15 comprises a first switch 151 and a second switch 152. The first switch 151 can for example be operable manually by a user of the vehicle, or else can be operable automatically if the optical system 5 is provided with a device for detecting impurities. It is the passage of the first switch 151 into the closed position which authorizes circulation of an electric current in the supply circuit 15 of the pump 12. In FIG. 1, the first switch 151 is in the open position. The cleaning system 1 is therefore inactive.

The electric generator 14 also supplies the electrical circuit 16 mentioned above. The electrical circuit 16 extends to each of the two electrical terminals 41 of the switch, passing through the structure of the tubular portion 37 and the end walls 38 of the cylinder body 31. For an electric current to flow within the electrical circuit 16, the latter must be closed for example by a conductive bridge between each of the two electrical terminals 41, as will be described later. The electrical circuit 16 also comprises an electrical relay 17 able to act on the second switch 152 of the supply circuit 15 of the pump 12. The second switch 152 is here in the closed position.

FIG. 2 shows the cleaning system 1 as described above. In FIG. 2, the cleaning system 1 is engaged, either manually or automatically. The first switch 151 therefore switches to the closed position and an electric current generated by the electric generator 14 can circulate in the supply circuit 15 and supply the pump 12. The latter starts up and pumps the cleaning fluid from the reservoir 11 to the chamber 32 of the cylinder 3 via the pipe 13. The cleaning fluid accumulates within the chamber 32 and exerts a pressure on the piston 33, the latter having a seal such that the cleaning fluid cannot infiltrate between the piston 33 and the tubular portion 37. The pressure exerted by the cleaning fluid on the piston 33 forces its movement in the direction of the first end wall 381. Said pressure has a higher force than the force exerted by the spring 39 on the piston 33. The spring 39 is therefore compressed under the effect of the movement of the piston 33. The movement of the piston 33 also causes the emergence of the rod 34 out of the cylinder body 31.

While causing the piston 33 to move, the cleaning fluid also flows within the circulation channel 35. The small diameter of the latter allows the cleaning fluid to increase its pressure at the outlet of the circulation channel, that is to say at the spraying element 36. The cleaning fluid circulates within the entirety of the circulation channel 35 before being sprayed by the spraying element 36. The cleaning fluid is therefore sprayed in a direction relative to the positioning of the spraying element 36 but also according to the emergence of the rod 34. The optical system 5 is arranged so that the cleaning fluid is necessarily sprayed onto it when the rod 34 emerges.

FIG. 3 is a schematic representation of the cleaning system 1 as shown above. From a chronological point of view, FIG. 3 represents the logical continuation of FIG. 2. The piston 33, still subjected to the pressure exerted by the cleaning fluid, continues its movement within the cylinder body 31 until it comes close to the first end wall 381. With the electrical terminals 41 emerging from the latter, the piston 33 comes into contact with the electrical terminals 41. The spring, not shown here, is compressed to its maximum.

As mentioned above, the contacting member 42 is carried by the piston 33. It is therefore the contacting member 42 which comes into contact with the electrical terminals 41, the assembly forming the switch 4. It is in this situation that the latter is activated. Specifically, the electrical circuit 16 is initially interrupted between the two electrical terminals 41 because the latter are not directly connected to each other. The contacting member 42 being electrically conductive when the latter comes into contact with the two electrical terminals 41 simultaneously, the electric current is then capable of flowing from one electrical terminal 41 to the other, which causes the activation of the switch 4 and the closure of the electrical circuit 16.

When the electrical circuit 16 is closed, the electrical relay 17 is then supplied with electric current and modifies the position of the second switch 152. The latter then switches to the open position and therefore cuts the passage of electric current within the supply circuit 15. This cut causes the pump 12 to be put out of operation.

At this precise moment, with the cleaning fluid no longer exerting pressure on the piston 33, the cleaning fluid is no longer sprayed by the spraying element 36. When the piston 33 and the rod 34 are in such a position, that is to say so that the switch 4 is activated, the spraying element 36 is sure to have sprayed cleaning fluid onto the optical system 5. It is therefore unnecessary to continue spraying cleaning fluid, which in this situation would be wasted. With the activation of the switch 4 causing the stopping of the spraying of the cleaning fluid, the latter is then saved, and this all while having the certainty that the optical system 5 has been cleaned during the movement of the rod 34 such as shown in the previous figure.

FIG. 4 still shows the same cleaning system 1, after activation of the switch. Thus, the spraying element 36 no longer sprays cleaning fluid, the pump 12 is stopped, and the cleaning fluid present in the chamber 32 no longer exerts pressure on the piston 33. Without cleaning fluid pressure, it is the spring 39 which has the greatest force. The latter is therefore able to relax in order to resume its initial position as shown in FIG. 1. Thus, the spring 39 exerts a pressure on the piston 33 and causes it to move in the opposite direction to what has been described above, that is to say in the direction of the second end wall 382.

The cleaning fluid contained in the chamber 32 is subjected to the pressure exerted by the movement of the piston 33 and is then forced into the pipe 13. The pipe 13 has a larger diameter than the diameter of the circulation channel 35. Thus, the cleaning fluid flows naturally within the pipe 13 and the pump 12 rather than within the circulation channel 35. The cleaning fluid, in the absence of the activity of the pump 12, thus returns to its starting point, namely the reservoir 11.

The movement of the piston 33 also causes the deactivation of the switch, the contacting member 42 being carried by the piston 33. The electrical circuit 16 is therefore again interrupted between the two electrical terminals 41, which causes the passage of the second switch 152 into the closed position. With the first switch 151 having reopened in the meantime, the closing of the second switch 152 does not cause the reactivation of the pump 12. The movement of the piston 33 continues until the spring 39 has resumed its initial shape.

FIG. 5 represents a second embodiment of the cleaning device 2 within the cleaning system 1, after activation of the pump 12. The only difference between the two embodiments lies in the nature and in the positioning of the switch. Reference will therefore be made to the description of FIG. 1 for the general presentation of the cleaning system 1 and to the description of FIG. 2 for the progression of the cleaning method at the stage as shown in figure s. According to the second embodiment of the cleaning device 2, the switch is divided into two parts, by reason of a magnet 43 and a magnetic sensor 44.

The magnet 43 is carried by the piston 33. More particularly, the magnet 43 is arranged on a portion of the piston 33 located in contact or substantially in contact with the tubular portion 37 of the cylinder body 31. The magnet 43 is crossed by a first transverse plane 101 passing through the center of the magnet 43. By transverse is meant a direction perpendicular to the rod 34. The magnet 43 is connected to the piston at an outer peripheral portion of the piston 33.

The magnetic sensor 44 is arranged around or within the tubular portion 37, as close as possible to the chamber 32. Like the electrical terminals of the first embodiment of the cleaning device 2, the magnetic sensor 44 is also connected to the electrical circuit 16. The magnetic sensor is connected to the two ends of the electrical circuit 16 and keeps the latter open. The magnetic sensor 44 is crossed by a second transverse plane 102 passing through the center of the magnetic sensor 44. By transverse is meant a direction perpendicular to the rod 34.

Just as has been previously described, the piston 33 moves in the direction of the first end wall 381 under the pressure of the cleaning fluid which fills the chamber 32 of the cylinder 3. At the same time, the cleaning fluid is sprayed against the optical system 5 via the spraying element 36. For the explanations relating to the supply circuit 15 and to the electrical circuit 16, reference will be made to what has been described in relation to FIGS. 1 to 4, such a description applying, mutatis mutandis, to the second embodiment illustrated in FIGS. 5 and 6.

FIG. 6 is a schematic representation of the second embodiment of the cleaning device 2 within the cleaning system 1 as shown above. From a chronological point of view, FIG. 6 represents a stage which immediately follows that illustrated in FIG. 5. Thus, the piston 33 continues its movement in the direction of the first end wall 381. The movement of the piston 33 logically causes a movement of the magnet 43 carried by it.

This movement continues until the piston 33, more precisely the magnet 43, comes opposite the magnetic sensor 44 arranged within the tubular portion 37. For the magnet 43 and the magnetic sensor 44 to face each other, it is necessary that the first transverse plane 101 passing through the center of the magnet 43 and the second transverse plane 102 passing through the center of the magnetic sensor 44 coincide with each other.

When the magnet 43 and the magnetic sensor 44 face each other, the switch 4 is activated. The magnetic capacity of the magnet 43 causes the attraction of an electrically conductive blade arranged within the magnetic sensor 44 which makes it possible to close the electrical circuit 16. Like the first embodiment, an electric current then flows in the electrical circuit 16, thus supplying the electrical relay 17 which opens the second switch 152 in order to interrupt the supply circuit 15 and to stop the operation of the pump 12. Thus, the activation of the switch 4 causes the stoppage of the pump 12, and therefore the stoppage of the movement of the piston 33 as well as of the spraying of cleaning fluid via the spraying element 36. The piston 33 is then moved in the opposite direction, toward the second end wall 382, by the force exerted by the spring 39 on the piston 33, as depicted in FIG. 4.

Regarding the second embodiment of the cleaning device 2, it is possible to arrange the magnetic sensor 44 at a plurality of positions along the tubular portion 37 of the cylinder body 31. Thus, depending on the position of the magnetic sensor 44 chosen, it is possible to determine at what level of the chamber 32 the movement of the piston 33 is interrupted. Consequently, it is therefore also possible to determine to what extent the rod 34 emerges from the cylinder body 31. In summary, it is possible to determine the field of action of the spraying of the cleaning fluid by the spraying element 36 according to the position chosen for the arrangement of the magnetic sensor 44. The second embodiment of the cleaning device 2 is therefore customizable, whether as original equipment or as a retrofit, which facilitates the adaptation of the latter, for example according to the vehicle model, the size of the optical system 5 or the position of the optical system 5 relative to the cleaning system 1.

It is also possible, for example, to imagine a plurality of magnetic sensors 44 arranged within the tubular portion 37 of the cylinder body 31, coupled to an electronic assembly making it possible to determine at which magnetic sensor 44 the movement of the piston 33 must be interrupted. The second embodiment of the cleaning device 2 therefore ensures that cleaning fluid savings are maximized when cleaning the optical system 5.

Of course, the invention is not limited to the examples that have just been described, and numerous modifications can be made to these examples without departing from the scope of the invention.

The invention, as it has just been described, successfully achieves the aim it had set itself, and makes it possible to propose a cleaning device for an optical system comprising a switch serving to stop the spraying of a cleaning fluid so as to save it. Variants not described here could be implemented without departing from the context of the invention, provided that, in accordance with the invention, they comprise a cleaning device in accordance with the invention.

1- A cleaning device (2) for cleaning at least one optical system (5) of a vehicle, comprising a cylinder (3) which comprises a cylinder body (31) which delimits a chamber (32), a piston (33) capable of moving in the chamber (32), and a rod (34) connected to the piston (33), one end of the rod (34) emerging from the cylinder body (31), said rod (34) comprising at least one cleaning fluid spraying element (36) provided at the end of the rod (34), the rod (34) comprising at least one cleaning fluid circulation channel (35) which connects the chamber (32) to said at least one spraying element (36), characterized in that the cleaning device (2) comprises a switch (4) activated according to the position of the piston (33).

2- The cleaning device (2) as claimed in claim 1, wherein the switch (4) comprises at least two electrical terminals (41) integral with the cylinder body (31) and a contacting member (42) carried by the piston (33), the switch (4) being configured to be activated when said at least two electrical terminals (41) are electrically brought into contact by the contacting member (42).

3- The cleaning device (2) as claimed in claim 2, wherein the cylinder body (31) comprises a tubular portion (37) having two ends, and two end walls (381, 382) arranged respectively at said two ends, said at least two electrical terminals (41) being carried by one of the end walls (381, 382).

4- The cleaning device (2) as claimed in claim 1, wherein the switch (4) comprises at least one magnet (43) carried by the piston (33) and at least one magnetic sensor (44) carried by the cylinder body (31), the switch (4) being configured to be activated when said at least one magnet (43) is facing said at least one magnetic sensor (44).

5- The cleaning device as claimed in claim 4, wherein the cylinder body (31) comprises a tubular portion (37) comprising two ends, and two end walls (381, 382) arranged respectively at said two ends, said at least one magnetic sensor (44) being arranged in the tubular portion (37).

6- The cleaning device (2) as claimed in claim 5, wherein the switch (4) comprises a plurality of magnetic sensors (44) configured to be arranged in a plurality of positions along the tubular portion (37).

7- A cleaning system (1) for cleaning at least one optical system (5) of a vehicle, comprising at least one cleaning device (2) as claimed in any one of the preceding claims, a cleaning fluid reservoir (11) and a pump (12) which transfers the cleaning fluid from the reservoir (11) to the chamber (32) of the cylinder (3), the operation of the pump (12) being placed under the dependence of the switch (4).

8- The cleaning system (1) as claimed in the preceding claim, wherein the operation of the pump (12) is interrupted upon activation of the switch (4).

9- A method for cleaning an optical system (5) of a vehicle implementing a cleaning system (1) as claimed in claim 7 or 8, in which:
the pump (12) is put into operation so as to cause a movement of the piston (33) and spraying of the cleaning fluid onto the optical system (5),
the switch is activated according to the position of the piston (33), and
the operation of the pump (12) is interrupted when the switch (4) is activated.
